(19) United States
(12) Patent Application Publication
(10) Pub. No.: US 2014/0279398 A1
(43) Pub. Date: Sep. 18, 2014

(54) ABILITY TO PAY CALCULATOR

(71) Applicants: Robert B. STEWART, Wilmington, DE (US); Nancy L. OZUN, Las Vegas, NV (US); Jill A. OUIMETTE, Las Vegas, NV (US); Michael M. RAFFETY, Las Vegas, NV (US); Ravikanth R. NARASIMHAREDDYGARI, Wheeling, IL (US); Lijing SUN, Union City, CA (US)

(72) Inventors: Robert B. STEWART, Wilmington, DE (US); Nancy L. OZUN, Las Vegas, NV (US); Jill A. OUIMETTE, Las Vegas, NV (US); Michael M. RAFFETY, Las Vegas, NV (US); Ravikanth R. NARASIMHAREDDYGARI, Wheeling, IL (US); Lijing SUN, Union City, CA (US)

(73) Assignee: CAPITAL ONE FINANCIAL CORPORATION, McLean, VA (US)

(21) Appl. No.: 14/210,861

(22) Filed: Mar. 14, 2014

Related U.S. Application Data
(60) Provisional application No. 61/790,100, filed on Mar. 15, 2013.

(51) Int. Cl. G06Q 40/02

(52) U.S. Cl. CPC G06Q 40/025
USPC 705/38

(57) ABSTRACT

The disclosed embodiments include methods and systems for collecting, managing, and processing data for lending services. In one embodiment, a computerized system is disclosed that may receive a loan request from a customer, and collect data from the customer and third parties having information about the customer. The system may utilize the collected data in an ability-to-pay (ATP) calculator to determine the customer's ability to pay the requested loan, in addition to the customer's current financial obligations, and considering additional contextual factors. Different selectable versions of the ATP calculator may incorporate different contextual data and non-traditional financial data to provide a customized, accurate determination of the customer's ability-to-pay.

### CROSS REFERENCE TO RELATED APPLICATION

This application claims priority under 35 U.S.C. §119 to U.S. provisional patent application No. 61/790,100, filed on Mar. 15, 2013, and entitled “Ability To Pay Calculator,” which is incorporated herein by reference in its entirety.

### TECHNICAL FIELD

The present disclosure relates generally to account management technologies and, in particular, to methods and systems for providing ability to pay mechanisms.

### BACKGROUND

Approving a loan or line of credit is generally a complex process of balancing risk and evaluating financial health. The process often requires several manual steps, and significant time and resource commitments to gather and evaluate all of the detailed financial records. Furthermore, basic financial records alone, such as credit reports and bank account records, frequently fail to provide an accurate and comprehensive representation of the applicant's financial situation. Standard information aggregators, such as credit bureaus, do not provide the detailed information necessary for a lender to make a well-educated determination of the borrower's ability to pay. Recent government regulations require more comprehensive determinations of the applicant's ability to pay (ATP) the loan or line of credit in view of their existing debt.

Furthermore, different types of loans, mortgages, and lines of credit may call for different types of information to properly evaluate risk. For example, a borrower may seek financing for a purchase that is known to be a risky investment. The lender would want additional information about the nature of the investment, and apply more levels of scrutiny to the borrower's financial situation. As another example, a borrower's credit history may contain little information due to few credit lines, or the borrower's young age. In order to determine the borrower's ATP in such situations, the lender would need to collect more information that may not be deduced from credit reports and bank statements alone.

Conventional ATP calculation programs only consider basic information, such as the borrower's debts and assets, as obtained from their credit report and/or questioning the borrower. Furthermore, the conventional debt to income (DTI) ratio calculation is too generalized for the vast diversity of possible financial situations. Attempts to incorporate additional information requires complex manual calculations to be performed by the lender. In a call center environment or in-person with the borrower in an office, these complex manual calculations are very prone to error. Furthermore, manual calculations of ATP may vary between employees in a financial service provider, depending on what information is requested from the borrower, leading to more inconsistency in financing decisions.

The disclosed embodiments include methods and systems that address the challenges associated with calculating a borrower's (hereinafter referred to as “customer”) ATP. Aspects of the disclosed embodiments are set forth below in this disclosure.

### SUMMARY

Consistent with the disclosure, systems and methods are provided for determining a customer's ability to pay a debt. In one embodiment, an apparatus for determining ability to pay a debt is disclosed. The apparatus may comprise, for example, one or more memory devices having stored thereon software instructions. The apparatus also includes one or more processors configured to execute the software instructions. The software instructions, when executed, may instruct the one or more processors to provide a calculator having a plurality of selectable versions, receive selection of a calculator version, receive income data, receive debt data, wherein the debt data includes an amount of a requested loan, calculate an amount of total obligations based on the debt data, calculate an amount of net disposable income, calculate a debt to income ratio, determine ability to pay the requested loan, and provide an indication of ability to pay the requested loan.

In another embodiment, a computer-implemented method for determining ability to pay a debt is disclosed. The computer-implemented method may include, for example, providing, by one or more processors, a calculator having one or more selectable versions; receiving a selection of a calculator version. The method may also include receiving income data and receiving debt data. In one aspect, the debt data may include an amount of a requested loan. The method may also include calculating, by the one or more processors, an amount of total obligations based on the debt data and calculating, by the one or more processors, an amount of net disposable income. The method may also include calculating, by the one or more processors, a debt to income ratio and determining, by the one or more processors, ability to pay the requested loan. Also, the method may include providing, by the one or more processors, an indication of ability to pay the requested loan.

Although the disclosed embodiments are discussed primarily in the context of individual loans (e.g., mortgages, lines of credit, personal loans, etc.), the disclosed embodiments are not limited to such products or types of consumers. For example, the disclosed embodiments may be also used in connection with other types of financial service provider accounts or products requiring repayment, and with other types of consumers (e.g., small and large businesses, organizations, government agencies, etc.).

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 is a block diagram of an exemplary system consistent with disclosed embodiments.

FIG. 2 is a block diagram of an exemplary financial service provider system, consistent with disclosed embodiments.

FIG. 3 is a block diagram of an exemplary lending system, consistent with disclosed embodiments.

FIG. 4 is a block diagram of an exemplary customer system, consistent with disclosed embodiments.

FIGS. 5A-5B are flowcharts of an exemplary ATP determination process, consistent with disclosed embodiments.

FIG. 6 shows a flow chart of an exemplary ATP results calculation and display process, consistent with disclosed embodiments.

FIG. 7 is an illustration of an exemplary financial institution user interface, consistent with disclosed embodiments.

FIG. 8 is a first illustration of an exemplary ATP calculator, consistent with disclosed embodiments.

FIG. 9A is a second illustration of an exemplary ATP calculator, consistent with disclosed embodiments.

FIG. 9B shows a flow chart of another exemplary results calculation and display process, consistent with disclosed embodiments.

FIG. 10 is a third illustration of an exemplary ATP calculator, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments include methods, systems, and articles of manufacture that may be configured to provide, for example, calculations and processing related to loan and credit applications. In one embodiment, a financial service provider system, such as a computer system operated by a bank representative, may be particularly configured to execute software instructions to collect financial data from customers, business entities, credit reporting agencies, and/or other financial institutions, and store the information in memory. Based on the collected data, the system may make determinations about the customer, such as the customer's ability to pay (ATP) a requested loan.

The disclosed embodiments include a computerized ATP Calculator that may automatically perform, or perform in response to user input, one or more calculations and processes for assessing a customer's ability to pay debt, based on predetermined rules and collected data, such as the collected data exemplified above. In one aspect, the ATP calculator may be an application that is stored in and executed by a computer system operated by a user, such as a financial service representative. The ATP Calculator may, when executed by the computer system, provide user interfaces that enable a user to request, receive, and manipulate information determined by the ATP Calculator software processes. In certain aspects, the ATP Calculator may be configured to include a plurality of user selectable versions, each tailored to different customer financial situations or needs. Based on user selections, and customer specific data, the ATP Calculator may generate different interfaces including different information that is calculated by the software based on previous user selections and input. The determined information and user interfaces may guide a user through an efficient and easily understandable ATP process.

For example, the disclosed embodiments may provide an ATP Calculator version that evaluates the ATP for a customer with little credit or no history. Another version of the ATP Calculator may evaluate the ATP for a customer seeking to purchase a risky item. The version of the ATP calculator selected may result in a graphic user interface that indicates which of the many different types of financial and contextual data about the customer are needed to determine the customer's ATP. In certain aspects, the disclosed embodiments may automatically analyze the collected data, and indicate whether additional data is needed for ultimately determining whether the customer has the ability to pay the requested loan. The ATP Calculator may recalculate and display updated results in real-time as data is entered or changed, to provide immediate feedback to a user (e.g., a financial service provider representative) regarding the customer's ability to pay. As a result, the user (e.g., financial service provider representative) may make decisions quickly, efficiently, and accurately regarding whether the customer should be approved for the loan, and the level of associated risk. In other embodiments, the information calculated by the ATP Calculator software may be provided to software process(es) that automatically determines whether the customer should be approved for a loan.

The disclosed embodiments include systems and processes for determining a customer's ATP a debt. In certain embodiments, debt may include, for example, a personal loan (e.g., a loan to an individual and not a business entity), business loans (e.g., a loan to a business entity), a home equity loan, mortgage, a line of credit, vehicle loan, a credit card account (e.g., private or primary), credit for purchasing goods or services, or any other type of loan, credit, and the like. In certain embodiments, and for exemplary purposes to describe certain aspects of the disclosed embodiments, the various types of debts associated with the disclosed embodiments may be collectively referred to as a “loan.” The disclosed embodiments, however, are not limited to loans as exemplified above. A debt, in accordance with the disclosed embodiments, may be associated any type of loan or financial service product consistent with the disclosed embodiments.

In certain embodiments, a customer may include, for example, a person or entity that may request to obtain a new or modified loan, or purchase or obtain a good or service having associated therewith a debt to be repaid. As a few examples, a customer may be an individual that may apply for a new credit card from a financial service provider, request an increase to an existing credit line, apply for a new mortgage, apply for refinancing a current mortgage, apply for financing to purchase a car, apply for financing to lease a car, etc. A customer is not limited to the above examples. For instance, a customer may be a business entity that, for example, seeks a business loan from a financial service provider.

The disclosed embodiments include, for example, systems and processes for evaluating a customer's application for assuming a new debt, identifying products, services, or promotional offers for individuals based on their ability to pay, evaluating risk in business agreements between companies or individuals, or even by individuals who wish to estimate the maximum debt that they could assume.

FIG. 1 is a block diagram of an exemplary system 100 for performing one or more operations consistent with certain disclosed embodiments. In one embodiment, system 100 may include a financial service provider 110, lending system 130, one or more customer systems 150, and network 140. The components and arrangement of the components included in system 100 may vary. Thus, system 100 may further include one or more data reporting agencies 170 (single exemplary data reporting agency 170 shown) that perform or assist in the performance of one or more processes consistent with the disclosed embodiments, such as other third party sources of financial data, statistical data, rules, or guidelines.

Financial service provider 110 may be an entity that provides financial services, such as a bank, credit card issuer, mortgage lender, a merchant who extends lines of credit or purchase financing to customers, or other type of financial service entity that generates, provides, manages, and/or maintains financial service accounts for one or more users. Financial service accounts may include, for example, credit card accounts, loan accounts, capital loan accounts, checking accounts, savings accounts, reward accounts, and any other types of financial service account known to those skilled in the art. In certain embodiments, financial service provider 110 may be a lender that provides one or more types of loans for customers (e.g., businesses and/or individuals).

In one embodiment, financial service provider 110 may include one or more computing systems that are configured to execute software instructions stored on one or more memory devices to perform one or more operations consistent with the disclosed embodiments. In one embodiment, financial service provider 110 may include server 111. Server 111 may be one or more computing devices configured to execute software instructions stored in memory to perform one or more processes consistent with the disclosed embodiments. For example, server 111 may include one or more memory device(s) storing data and software instructions and one or more processor(s) configured to use the data and execute the software instructions to perform server-based functions and operations known to those skilled in the art. Server 111 may be a general purpose computer, a mainframe computer, or any combination of these components. Server 111 may be standalone, or it may be part of a subsystem, which may be part of a larger system. For example, server 111 may represent distributed servers that are remotely located and communicate over a network (e.g., network 140) or a dedicated network, such as a LAN, for financial service provider 110.

Server 111 may include or may connect to one or more storage devices configured to store data and/or software instructions used by one or more processors of server 111 to perform operations consistent with disclosed embodiments. For example, server 111 may include memory configured to store one or more software programs that performs several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides web site(s) that are accessible over network 140. In other aspects, financial server provider 110 may connect separate web server(s) or similar computing devices that generate, maintain, and provide web site(s) for financial service provider 110.

In certain aspects, a user 112 may operate one or more components of financial service provider (e.g., server 111) to perform one or more operations consistent with the disclosed embodiments. In one aspect, user 112 may be an employee of, or associated with, financial service provider 110 (e.g., someone authorized to use components of server 111 or perform processes for financial service provider 110). In other aspects, user 112 may not be an employee of, or otherwise is associated with financial service provider 110. In further aspects, user 112 may be an employee of a third party entity which issues lines of credits or loans. For example, user 112 may be an individual working for a financial service provider such as loan officers, loan specialist, financial analyst, credit card company employee, bank employee, lender employee, or any individual who wishes to determine a customer's ability to pay a debt.

Customer system 150 may be used by customer 152 who, for example, seeks to obtain a loan. For instance, customer system 150 may be a personal computer of customer 152 seeking to obtain a personal loan. As disclosed herein, a customer terminal or customer system may relate to customer system 150. The disclosed embodiments may be implemented in configurations where customer system 150 is associated with a small business, a large business, a non-profit based organization, a profit-based organization, a government agency, or any other type of entity or individual (or groups of individuals) that may request, receive, access, manage, or the like, financial services from financial service provider 110. Further, customer 152 and customer system 150 are not limited to any particular industry or field. For example, customer system 150 may be operated by a customer associated with a company that manufactures semiconductor chips, whereas customer system 150 may be operated by a customer associated with a company that supplies automobile parts. The type, configuration, and size of entity or business operating customer system 150 is not limiting to the disclosed embodiments.

A customer system 150 may include one or more computing devices that perform data processing and data communication with network 140. For example, customer system 150 may include a personal general purpose desktop computer, laptop, notebook, tablet, smart phone, or any other device with data processing and data communication capabilities. In some aspects, customer system 150 may be a wired or wireless device such as a PDA, cellular phone, mobile telephone, cordless phone, or corded telephone through which customer 152 provides information via touch-tone entry or by voice.

In some embodiments, customer system 150 may include one or more computing devices configured to execute software instructions stored in memory to perform one or more processes consistent with the disclosed embodiments. For example, customer system 150 may include one or more memory device(s) storing data and software instructions and one or more processor(s) configured to use the data and execute the software instructions to perform server-based functions and operations known to those skilled in the art. Customer system 150 may also be configured to execute stored software instructions to perform operations consistent with disclosed embodiments. Customer system 150 may be a general purpose computer, a mainframe computer, or any combination of these components that when executing software processes consistent with the disclosed embodiments, are particularly configured to perform disclosed processes. Customer system 150 may be standalone, or it may be part of a subsystem, which may be part of a larger system. In other embodiments, customer system 150 may be a computing device configured to operate as a server and/or a client. The type and configuration of customer system 150 is not limiting to the disclosed embodiments.

In certain embodiments, a customer 152 may operate customer system 150 to perform one or more processes consistent with the disclosed embodiments. For example, a customer 152 may access, use, and otherwise operate customer system 150 to perform processes such as, data entry and transmission via network 140 to financial service provider 110 and/or lending system 130. Customer 152 may also access, use, and otherwise customer system 150 to perform similar processes, as well as additional processes associated with a business operated by customer 152. In such an example, customer 152 may operate business software executed by computing components on customer system 150 and can work with the computing components to provide financial data to financial service provider 110 and/or lending system 130 over network 140. In some embodiments, financial data may include monthly utility bills, insurance bills, living expenses, tax bills, state and federal tax returns, income records such as paycheck statements or paystubs, mortgage bills, personal loan bills, student loan bills, home equity credit line statements, credit card statements, debit card statements, savings and checking account statements, asset values, investment portfolio values, and any other financial information related to the income, assets, trusts, obligations, and debts of customer 152.

Lending system 130 may include a computing system configured to perform one or more lending processes consistent with disclosed embodiments. For example, lending system 130 may be a computer system (e.g., a laptop, desktop, computer terminal, tablet, mobile smart device, etc.) that executes one or more software applications (e.g., ATP Calculator application) configured to perform ATP processes consistent with certain embodiments. The software application(s) may be executed by lending system 130 and manipulated, initiated, and otherwise operated, through known software application and operating system environments and mechanisms. For instance, lending system 130 may store an ATP Calculator application that is opened and run by a user through selections of icon(s), drop down menu(s), etc., similar to processes for opening and running known software applications, such as a word processing or database application on a desktop.

In one embodiment, lending system 130 may be included as a component of financial service provider 110 (as exemplified in FIG. 1). In other embodiments, lending system 130 may be a remote system that can communicate with components of financial service provider 110, via, for example, network 140. In one aspect, a user 112 may operate lending system 130, or components of lending system 130, that perform one or more operations for processing, managing, approving, assessing, and maintaining financial accounts, such as loan products (e.g., line of credit, etc.). In some embodiments, lending system 130 may be associated with an entity other than financial service provider 110 (e.g., lender entity) that provides loan services, including assessing and providing loans. For example, the lender entity may be a company, individual, or other type of entity that provides lender system 130 for use by user 112, such as a laptop, mobile device, desktop, etc. used by an employee of the business entity.

In certain aspects, lending system 130 may include, or may be connected to and operate with one or more components that provide an online portal that provides a mechanism for customer 152 to request, receive, and send data that is used for performing one or more operations of the disclosed embodiments. For example, lending system 130 may include, or connect to, one or more web servers that generate, maintain, and manage web site pages that provide interfaces that are accessed by users, such as customer 152, using browser software executing in the computing components of customer system 150.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary link between financial service provider 110.

Data reporting agency 170 may be any third party entity that provides information to lending system 130 and/or financial service provider 110 for determining ATP for a customer 152. As a common example, data reporting agency 170 may be a credit reporting agency, such as Equifax™, Experian™, or Trans Union™. Data reporting agency 170 may also include other financial service providers such as banks or credit card companies where customer 152 holds one or more accounts. In some aspects, data reporting agency 170 may be private or government entities that provide census data, statistical data such as average living expenses for different geographical areas, pricing and value data for valuing items or assets, tax rates, or interest rate data for certain periods of time. Data reporting agency 170 may include one or more may computing devices such as a server (not shown) for sending and receiving data via network 140. In some aspects, data reporting agency 170 may have one or more employees who provide information to lending system 130 and/or financial service provider 110 via telephone, real-time discussion, or in writing, in response to requests for information.

FIG. 2 shows an exemplary system that may be associated with financial service provider 110. In one embodiment, the system may include a server 211 having one or more processors 221, one or more memory 223, and one or more input/output (I/O) devices 222. Alternatively, server 211 may take the form of a general purpose computer, a mainframe computer, or any combination of these components. Server 211 may be standalone, or it may be part of a subsystem, which may be part of a larger system. Server 211 may correspond to server 111 shown in FIG. 1 and described above in connection with system 100.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 211.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider 110, via server 211, may access one or more remote programs, such as ATP Calculator 326 (shown in FIG. 3), that, when executed, perform functions related to certain disclosed embodiments.

Memory 223 may also store data 225 that may reflect any type of information in any format that financial service provider 110 may use to perform financial service provider functions. For example, data 225 may include financial records associated with customers of financial service provider 110 (e.g., customer 152).

I/O devices 222 may be one or more devices configured to allow data to be received and/or transmitted by server 211. I/O devices 222 may include one or more digital and/or analog communication devices that allow server 211 to communicate with other machines and devices, such as customer system 150.

Server 211 may also be communicatively connected to one or more database(s) 227. Server 211 may be communicatively connected to database(s) 227 through network 140. Database 227 may include one or more memory devices that store information and are accessed and/or managed through server 211. By way of example, database(s) 211 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider 110 may include database 227. Alternatively, database 227 may be located remotely from financial service provider 110. Database 227 may include computing components (e.g., database management system, database server, etc.) configured to receive and process requests for data stored in memory devices of database(s) 227 and to provide data from database 227.

FIG. 3 shows an exemplary system that may be associated with lending system 130. In one embodiment, the system may include a computing system 311 having one or more processors 321, one or more memories 323, and one or more input/output (I/O) devices 322. Computing system 311 may be a general purpose computer, a mainframe computer, or any combination of these components that is configured in a particular configuration based on software processes that perform operations consistent with the disclosed embodiments. Computing system 311 may be standalone, or it may be part of a subsystem, which may be part of a larger system.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in computing system 311.

Memory 323 may include one or more storage devices configured to store instructions used by processor 321 to perform functions related to disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include programs 324 that perform the functions of the computing system 311 and functions of the disclosed embodiments, such as an ATP Calculator 326. For example, ATP Calculator 326 may be a Windows-based application stored in memory 323. In some embodiments, ATP Calculator 326 may be executed on a UNIX-based system such as Linux or Macintosh OS X, or on a mobile platform such as Android or iOS. Additionally, processor 321 may execute one or more programs located remotely from computing system 311. For example, lending system 130, via computing system 311, may access one or more remote programs that, when executed, perform functions related to certain disclosed embodiments. In certain aspects, program(s) 324 may include software instructions that, when executed by processor(s) 321, perform lending service processes consistent with the disclosed embodiments, such as collecting financial data from customer 152, assessing loan applications, approving loan application, providing disbursements, and determining ability to pay debt for customer 152 to approve or disapprove a new loan from financial service provider 110.

Lending system 130 may include software that operates as a web server to provide web site(s) and web page(s) that include interfaces accessed by components of customer system 150 (e.g., computing system 151) through the direction of customer 152 or automated software processes. In one embodiment, lending system 130 may be configured to provide, or to connect to and operate with, an online lending service that customer 152 may access via network 140 to request loans, manage existing loans including requesting modifications to existing loans, view information relating to loan accounts with financial service provider 110, and upload financial data. Lending system 130 may also include computing components that are configured to communicate with customer system 150 that have registered with the online lending service to exchange business information through known business software communication mechanisms, including secure Internet-related communications, EDI, and any other type of communication link and protocols.

Memory 323 may also store data 325 that may reflect any type of information in any format that financial service provider 110 may use to perform financial service provider functions. For example, data 325 may include financial records associated with customers of financial service provider 110 (e.g., customer 152).

I/O devices 322 may be one or more devices configured to allow data to be received and/or transmitted by computing system 311. I/O devices 322 may include one or more digital and/or analog communication devices that allow computing system 311 to communicate with other machines and devices, such as customer system 150.

Computing system 311 may also be communicatively connected to one or more database(s) 330. Computing system 311 may be communicatively connected to database(s) 330 through network 140. Database 330 may include one or more memory devices that store information and are accessed and/or managed through computing system 311. By way of example, database(s) 330 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, lending system 130 may include database 330. Alternatively, database 330 may be located remotely from lending system 130. Database 330 may include computing components (e.g., database management system, database server, etc.) configured to receive and process requests for data stored in memory devices of database(s) 330 and to provide data from database 330. Lending system 130 may also include a data mart 327 that is configured to provide, control, and manage access to data stored in database 330. Data mart 327 may be configured to execute known data mart functions and operations.

FIG. 4 shows an exemplary customer system 150. In one embodiment, system 150 may include a computing system 411 having one or more processors 421, one or more memories 423, and one or more input/output (I/O) devices 422. In certain embodiments, computing system 411 may be a general purpose computer, a mainframe computer, or any combination of these components that executes software processes consistent with one or more operations consistent with the disclosed embodiments. Computing system 411 may be standalone, or it may be part of a subsystem, which may be part of a larger system. Computing system 411 may correspond to computing system 151 shown in FIG. 1 and described above in connection with system 100.

Processor 421 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in computing system 411.

Memory 423 may include one or more storage devices configured to store instructions used by processor 421 to perform functions related to disclosed embodiments. For example, memory 423 may be configured with one or more software instructions, such as program(s) 424 that may perform one or more operations when executed by processor 421. The disclosed embodiments are not limited to separate programs or computers configured to perform dedicated tasks. For example, memory 423 may include a single program 424 that performs the functions of the computing system 411, or program 424 could comprise multiple programs. Additionally, processor 421 may execute one or more programs located remotely from computing system 411. For example, customer system 150, via computing system 411, may access one or more remote programs that, when executed, perform functions related to certain disclosed embodiments.

Memory 423 may also store data 425 that may reflect any type of information in any format that customer 152 may use to perform operations consistent with the type of business affiliated with customer 152 operating customer system 150.

I/O devices 422 may be one or more devices configured to allow data to be received and/or transmitted by computing system 411. I/O devices 422 may include one or more digital and/or analog communication devices that allow computing system 411 to communicate with other machines and devices, such as customer system 150.

Computing system 411 may also be communicatively connected to one or more database(s) 430. Computing system 411 may be communicatively connected to database(s) 430 through network 140. Database 430 may include one or more memory devices that store information and are accessed and/or managed through computing system 411. By way of example, database(s) 430 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, customer system 150 may include database 430. Alternatively, database 430 may be located remotely from customer system 150. Database 430 may include computing components (e.g., database management system, database server, etc.) configured to receive and process requests for data stored in memory devices of database(s) 430 and to provide data from database 430.

As mentioned above, the disclosed embodiments are not limited to the use of a server for customer system 150. In certain aspects, computing system 411 may be a non-server type of computing device including the components shown in FIG. 4 and described above.

Certain disclosed embodiments may be configured to allow customer system 150 to communicate with lending system 130 and financial service provider 110. In certain aspects, financial service provider 110 may need to assess the credit worthiness of a customer 152 to determine whether to provide a loan to the business. The disclosed embodiments include, for example, systems, tangible computer-readable mediums, and methods for assessing the credit worthiness of a customer 152 to determine whether to provide a loan to the business.

In certain aspects, the disclosed embodiments may enable a customer 152 to interact with lending system 130 via customer system 150 to perform loan application processes. In order for lending system 130 to process loan applications for customer 152, lending system 130 may require certain types of information about the financial health of the customer 152, to determine the customer's ability to pay the loan in addition to the customer's preexisting financial obligations. The disclosed embodiments may include methods and systems that allow customer 152 to exchange information with lending system 130 via customer system 150, that may be used by financial service provider 110 (or server 111) to determine, assesses, generate, approve, process, and manage loan products for the customer 152. In one embodiment, customer system 150 may execute software instructions, via a processor(s) (e.g., processor 421), that automatically collects financial data from one or more data sources and uploads the financial data to lending system 130 over network 140 or other communication links. Data sources may include, for example, documents or spreadsheets stored on or in connection with customer system 150 having financial data such as paystubs, bills, and tax records. In other embodiments, customer system 150 may allow customer 152 to manually enter and transmit financial data to lending service 130 via input device components of customer system 150.

FIGS. 5A and 5B show a flow chart of an exemplary ATP determination process 500 consistent with certain embodiments. For exemplary purposes only, one or more of the processes of FIGS. 5A and 5B are described below as being performed by lending system 130, which as described above in connection with FIG. 1, may or may not be included with financial service provider 110. The disclosed embodiments are not so limited. For example, server 111 may be configured to execute software processes for performing one or more of the processes of FIGS. 5A and 5B. In certain embodiments, lending system 130 may store an application that when executed by one or more processors, performs one or more processes of FIGS. 5A and 5B.

In step 502 of FIG. 5A, lending system 130 may receive a request from customer 152 for a loan. The request may be received from customer 152 operating customer system 150 to access a website provided by server 111 and associated with financial service provider 110. In other embodiments, server 111 may receive the request through entry by a financial service provider 110 user 112, such as user 112 providing data directly to lending system 130 computing system 311, based on a telephone conversation between a financial service provider 110 user 112 and customer 152, or an in-person communication between a financial service provider 110 user 112 and customer 152. The request may be, for example, directed to obtaining a new loan or modifying an existing loan (e.g. obtaining a new line of credit or increasing a current line of credit, etc.).

In one embodiment, lending system 130 may execute one or more software applications that perform loan application processes consistent with disclosed embodiments. In one embodiment, user 112 may launch the application(s) by opening and running a program or programs stored in memory of lending system 130. In other embodiments, lending system 130 may be configured to automatically execute the application(s) in response the request received in step 502. The one or more applications may be stored on a non-transitory computer readable medium and executable by computing system 311 and/or server 211, depending on certain configurations.

In one embodiment, lending system 130 may execute a process to conduct an automated survey to request customer data and credit report authorization (step 504). During the survey, lending system 130 may ask customer 152 about the size of the loan desired and purpose of the loan. Lending system 130 may also request financial data such as details regarding the customer 152's current debts and income, and contextual data for customer 152 such as full name, address, social security number, and date of birth. In one aspect, lending system 130 may also request authorization to access customer 152's credit report and history. Lending system 130 (or server 111) may transmit requests during the automated survey to customer system 150 through network 140. Alternatively, if customer 152 is communicating in-person with financial service provider 110 user 112, the authorization request may be displayed to the customer on a computer at the office, or asked verbally by the representative operating a computer system associated with lending system 130 (e.g., computing system 311, or server 111 associated with financial service provider 110).

In step 506, lending system 130 may receive the requested customer data. For example, customer 152 may provide the customer data through customer system 150, such as through input components (e.g., a keyboard, touch screen, etc.) included in customer system 150. In other embodiments, some or all customer data may be verbally relayed to lending system 130 by voice, where computing system 311 may be configured to perform voice recognition and parsing processes known to those skilled in the art to generate data associated with the customer's spoken words. In one embodiment, where customer 152 may be communicating in-person (or telephonically) with financial service provider 110 user 112, computing system 311 (or server 111) may receive the customer data via manual entry by user 112.

In some aspects, requested customer data may be received by lending system 130 automatically. For example, if customer 152 already holds an account with financial service provider 110, some or all customer data already stored in association with their account may be collected automatically by logging into the customer's account, or by accessing memory associated with financial service provider 110 that stores the customer's account information such as database(s) 227. In other aspects, lending system 130 may request and receive information from customer 152 that grants lending system 130 access to one or more financial accounts held by other entities, such as by one or more data reporting agencies 170. For instance, lending system 130 may use authorization data provided by customer 152 to query the one or more data reporting agencies 170 to obtain some of all of the requested customer data.

In step 508, lending system 130 may receive authorization data from customer 152 to access one or more credit reports and/or credit histories from one or more data reporting agencies 170, such as a credit reporting agency. Based on the authorization data, lending system 130 may be configured to request and retrieve one or more credit reports from one or more data reporting agencies 170 (step 510).

In certain embodiments, lending system 130 may be configured to analyze the customer data and/or credit reports (if available and received) to determine debt-to-income (DTI) ratio for customer 152 (step 512). The disclosed embodiments may execute software processes that perform one or more algorithms that perform known DTI calculations.

In step 514, lending system 130 may determine whether the requested loan is approved based on the calculated DTI and credit report information. If the loan is approved, lending system 130 may generate and provide an indication of the approval in step 516 to customer 152. In other aspects, the indication may be displayed on a display screen of a representative associated with lending system 130.

If the loan is not approved, lending system 130 may determine and generate a reason code for the disapproval (step 518). In certain embodiments, lending system 130 may generate a reason code, for example, by matching certain aspects of the customer data, credit report data, and/or calculated DTI to a lookup table of reason codes. In other embodiments, lending system 130 may execute software processes that perform rules-based analysis to generate the reason code. For example, if the credit history for customer 152 contains insufficient data due to the customer's young age or general lack of credit experience, lending system 130 may generate a reason code reflecting that condition (e.g., reason code “A”). As another example, lending system 130 may generate a different reason code (e.g., reason code “B”) if it determines that the calculated DTI surpasses a predetermined threshold and thus is too high (e.g., reflecting possibly that the customer already has too much debt for their income). As a further example, lending system 130 may generate a different reason code (e.g., reason code “C”) if it determines that the customer is a high risk debtor due to a requested loan amount that surpasses a determined threshold value. Lending system 130 may be configured to generate reason codes based on rules, conditions, and other parameters, and may generate any type of representation for the reason codes (e.g., numeric, alpha-numeric, graphical, color codes, etc.).

In certain aspects, lending system 130 may be configured with predetermined criteria and thresholds for triggering respective reason codes. In one embodiment, the criteria and thresholds may correspond to values set according to government guidelines or industry standards. Lending system 130 may generate reason codes that indicate additional levels of scrutiny are required before the requested loan can be approved by the processes executed by lending system 130 (or server 111). For example, lending system 130 may generate a reason code that indicates and causes lending system 130 to request and receive additional information from customer 152 and/or requesting more data from data reporting agencies 170. In other embodiments, such reason codes may trigger additional questioning of the customer 152 by a representative associated with lending system 130.

In certain embodiments, lending system 130 may be configured to generate and forward a customer matter associated with the loan request based on the analysis performed (step 520). For example, in one embodiment, lending system 130 may generate a file that includes the collected customer data and analysis data and one or more reason codes, which may be forwarded to financial service provider 110 user 112 to conduct another processing stage of the ATP determination process. In another embodiment, lending system 130 may send the file to a determined user associated with financial service provider 110 for further processing, such as user 112. In other embodiments, lending system 130 may generate a customer matter file that is stored in a memory accessible by other computing systems (e.g., server 111) and generate and provide a notification to user 112 that the customer matter requires the attention and involvement of user 112. In one aspect, lending system 130 may generate and send an electronic communication to user 112, such as an e-mail, SMS message, etc. In other embodiments, the notification may be directed to a computer terminal associated with user 112. The disclosed embodiments may implement other mechanisms for notifying user 112 that the customer matter requires attention.

In one embodiment, referring to FIG. 5B, in step 522, lending system 130 may launch one or more software applications that comprise ATP Calculator 326. In some aspects, ATP Calculator 326 may be launched automatically when the user 112 analyzes or views the customer matter. In other aspects, user 112 may instruct lending system 130 to launch ATP Calculator 326 after reviewing the forwarded customer matter. Lending system 130 may access ATP Calculator 326 application(s) stored locally in memory 323, in server memory 223, or remotely via server 211. As previously mentioned, ATP Calculator 326 may include a number of different versions. In one example, ATP Calculator 326 may include six different versions, but may include greater or fewer selectable versions depending upon the needs of financial service provider 110. The disclosed embodiments allow different versions of ATP calculator 326 to be customized for different reason codes. By executing and providing different ATP Calculator versions, lending system 130 and/or user 112 may request and consider different pieces of customer data, to provide and/or determine a more accurate determination of ability to pay in different situations. Lending system 130 may automatically select an appropriate version of ATP Calculator 326 upon launch, based on the reason code generated (step not shown). Lending system 130 may select the ATP calculator version, for example, by querying a lookup table that correlates reason codes to calculator versions, or by rule-based logic. User 112 may select a different ATP Calculator 326 version if desired. Upon receiving selection of an ATP Calculator 326 version, lending system 130 may generate a graphic user interface corresponding to the selected version (step 524). Lending system 130 or another component of system 100 may be configured to automatically populate ATP calculator 326 with the previously collected customer data.

After populating the selected ATP Calculator 326 version with customer data, user 112 may verify the customer data with customer 152 (step not shown). In step 526, ATP Calculator 326 may prompt user 112 to collect additional data (step 526). The particular pieces of data prompted for collection may depend on the requirements of ATP Calculator 326 version. For example, a version of ATP Calculator 326 for customers 152 lacking credit history may prompt user 112 for authorization from customer 152 to gather information from additional data reporting agencies 170, such as banks where customer 152 holds savings or checking accounts. As another example, a version of ATP Calculator 326 for customers 152 for evaluating risky purchases may prompt user 112 to verify the type of item being purchased, and its intended use. As another example, if ATP Calculator 326 prompts user 112 to enter customer 152's monthly rent, which had not been previously collected during the automated survey, user 112 may now receive this additional information.

In some aspects, ATP Calculator 326 may prompt user 112 to verify abnormal data (referring still to step 526). For example, if customer 152 previously entered $60,000 as their monthly income (mistakenly thinking they were being asked for a yearly income) during the automated survey, ATP Calculator 326 may prompt user 112 to question customer 152, and receive a corrected monthly income of $5,000.

In step 528, ATP Calculator 326 may receive additional and/or corrected data. Upon receipt of the data, ATP Calculator 326 immediately processes all data to calculate updated results, and displays updated results (step 530). Displayed results may include, for example, debt-to-income ratio (DTI), ATP Status such as “Pass/Fail,” Minimum Income required for a requisite DTI (such as “Min Income for 50% DTI: $50,000”), maximum allowed loan amount, or any combination thereof. Displayed results may also include any additional statistics or determinations which may be useful for approving or disapproving the loan. However, in certain embodiments, ATP Calculator 326 may be configured to generate and provide a clean and easy-to-read interface with minimal clutter, to increase efficiency and consistency.

During the collection and processing of additional and/or corrected data, ATP Calculator 326 or user 112 may determine that a different version of ATP Calculator 326 is more suited to the needs of the financial services provider 110 (step 532). For example, if user 112 or lending system 130 learns that customer 152 intends to purchase a risky item (e.g., during a conversation or through electronically provided information), user 112 may wish to select a different ATP Calculator 326 version. As another example, if ATP Calculator 326 determines that customer 152's credit history is too vague despite an preliminary determination that the credit history was sufficient, ATP Calculator 326 may generate data that is provided in an interface that suggests selecting a different ATP Calculator version. In step 534, ATP Calculator 326 may receive a selection of a different calculator version, returning the process to step 524 for display of the newly selected calculator version. Furthermore, selection of a different ATP Calculator 326 version may cause lending system 130 to automatically populate some or all fields with the collected customer data remove the need for reentering data.

If the determination in step 532 is negative, ATP Calculator 326 may determine and indicate whether more data is required (step 536). To indicate the need for more data, ATP Calculator 326 may highlight fields of data that must be entered or reviewed (step not shown). If the determination is positive, the process returns to steps 526 and 528, where user 112 receives additional and/or corrected data requested via prompts from ATP Calculator 326. Once all required data is collected, and the determination in step 536 is negative, the process ends, and ATP calculator 326 continue to display the updated results (from step 530).

FIG. 6 shows a flow chart of an exemplary ATP results calculation and display process 530 consistent with certain disclosed embodiments. In certain aspects, lending system 130 and/or server 111 may perform one or more operations of process 530. As previously mentioned in reference to FIG. 5B, ATP Calculator 326 may continuously recalculate and generate interface(s) for displaying updated results as data is entered, received, removed, and/or updated. To calculate results, ATP Calculator 326 may calculate a debt-to-income (DTI) ratio for customer 152, for example by dividing a year's worth of total monthly obligations by customer 152's total annual income (step 610). Total monthly obligation may be determined by summing all monthly debts, including the estimated monthly payment for the requested loan. Total annual income may be determined by summing all entered income amounts. ATP Calculator 326 may display the calculated DTI in step 612. Net Disposable Income (NDI) may be calculated by subtracting total monthly obligation from monthly income (step 614).

In step 616, the ATP Calculator 326 may determine customer 152's minimum income required for a certain percentage DTI. For example, if financial service provider 110 requires a DTI of 50% or less, ATP Calculator 326 may calculate a required annual income to satisfy the DTI ratio, by determining a yearly debt amount (total monthly obligation×12), and multiplying the yearly debt amount by the inverse of the DTI percentage (i.e. ×1/0.5). ATP Calculator 326 may generate results data that is provided in an interface that displays the calculated Min Income Required in step 618.

In step 620, ATP Calculator 326 may compare NDI to a predetermined threshold, such as a minimum net disposable income amount required by financial service provider 110 to continue the application process. For example, ATP Calculator 326 may determine whether customer 152's NDI is less than or equal to $25. If NDI is below the predetermined threshold amount, ATP Calculator may set a MaxLimit representing the maximum loan amount available for customer 152 to zero in step 622, and display the MaxLimit in step 624. If NDI is equal to or greater than the predetermined threshold in step 620, ATP Calculator 326 may calculate a MaxLimit representing a loan amount available for customer 152 in step 626 by dividing NDI by RepayRate. In some embodiments, RepayRate may be a fixed minimum percentage of the loan balance that is due in each payment cycle. RepayRate may be a percentage predetermined by financial service provider 110 by considering factors such as government regulatory criteria, the financial service provider 110's predetermined risk policy statements, and an annual fee requirement that may or may not be applied to the customer 152's current account with financial service provider 110. For example ATP Calculator 326 may set RepayRate to 3.5% for customers 152 having accounts that do not have an annual fee, and set RepayRate to 5% for customers 152 having accounts that do have and annual fee. For example, if customer 152 has Net Disposable Income of $50 per month, and is given a 5% RepayRate, MaxLimit is set to $1,000 ($50/0.05).

In step 628, ATP Calculator 326 may be configured to compare the MaxLimit set in steps 622 or 626 to the loan amount requested by customer 152. If the MaxLimit is greater than or equal to the requested loan amount, ATP Calculator may determine that customer 152 is eligible to receive the requested loan and has the ability to pay. Accordingly, ATP Calculator 326 may display an ATP Status of “Pass” in step 630. If the determination in step 628 is negative, ATP Calculator may display an ATP Status of “Fail” in step 632.

ATP Calculator 326 may indicate ATP Status by displaying “Pass” or “Fail,” by colors such as green for “Pass” and red for “Fail,” or by a rating system. For example, ATP Status may be portrayed by a number rating of 1 to 10 (10 being best and 1 being worst), or by a display of stars, such as 5 stars being best and 1 star being worst. ATP Calculator 326 may determine the rating by calculating the difference between the MaxLimit and requested loan amount, and assigning, for example, a number or quantity of stars depending on the difference (not shown in detail).

In one embodiment, the ATP Status field may be configured to provide indication of the customer's financial health when the requested loan is taken under consideration. The ATP Status field may be configured to be presented in an easy-to-understand format to allow a user to parse and identify a customer's financial health. In certain embodiments, ATP Calculator 326 may display other numeric (or other formatted) results and data indicating ability to pay that may be reviewed or modified by user 112, which may provide a simple, graphical indication of the financial service provider's risk in issuing the requested loan.

FIG. 7 shows an exemplary user interface 700 that may be generated by the disclosed embodiments. In one aspect, interface 700 (or similar interface(s)) may be displayed on a display screen of lending system 130 operated by user 112. The illustration of user interface 700 is only exemplary, and the format and layout, and the look-and-feel may be changed such as by adding or removing elements, or rearranging the elements, etc. User interface 700 may include information relevant to a generated customer matter, such as the reason code 710 indicating one or more reasons the customer 152's requested loan was initially disapproved. Customer data 720, such as contextual and financial information collected during the automated survey, may be included in interface 700, such as the customer's name, telephone number, email address, mailing address, age, amount of loan requested, income amount, debt amount, and any other pertinent information previously entered by customer 152. The customer 152's Social Security Number may be included or omitted for security and privacy concerns. In some embodiments, user 112 may re-collect customer 152's Social Security Number, electronically or while conversing with customer 152. User interface 700 may include customer account information 730 when the customer already holds one or more accounts with financial service provider 110. User interface 700 may also include customer credit report information 740 that may include data received from data reporting agencies 170. User interface 700 may also include a portion for displaying information, content, results, data, etc. as an ATP Calculator portion 726, which may correspond to ATP Calculator 326. For example, ATP Calculator portion 726 may include blank fields or pre-populated fields corresponding to collected customer data (not shown in detail).

FIG. 8 shows an exemplary ATP Calculator 326 graphic user interface consistent with disclosed embodiments. In one embodiment, ATP Calculator 326 may generate and provide the exemplary interface of FIG. 8 (or one similar like it). In one aspect, the interface may include a “Select Calculator” box 810, which allows user 112 to dynamically select an ATP calculator 326 version. User 112 may select a version via toggle switches, drop-down menu, tabs, or any other suitable, easily accessible selection mechanism on the graphic user interface. As previously discussed, different versions (e.g. “A,” “B,” “C,” “D,” “E,” and “F”) may correspond to different reason codes and/or different situations. For example, version “A,” selected by the toggle switch for “A” on the ATP Calculator 326, may correspond to a generic version of ATP Calculator 326. Alternatively, version “A” may correspond to one or more reason codes, such as a reason code “A” indicating customer 152 having debt-to-income ratio that is above a predetermined threshold. ATP Calculator 326 version may be automatically set in box 810 according to a reason code received from server 111. As an advantage of the present embodiments, user 112 may dynamically change the version of ATP Calculator 326 currently in use. For example, if user 112 subsequently learns information from the customer that causes user 112 to decide a different version of ATP Calculator 326 would be more suitable, user 112 may simply select a different version in box 810. Upon receiving the selection of a different version, lending system 130 displays the graphic user interface associated with the selected ATP Calculator, and automatically populates customer data in fields of the newly selected version.

After receiving selection of a version, ATP Calculator 326 may receive income data for the customer 152 through input provided by a user using the “Income” box 812. Income data may include, without limitation, salary, bonuses, commission, rental income, investment dividends, gambling earnings, or any type of income, etc. Different categories of income may be parsed in ATP calculator 326, such as by having separate categories of prompts for “income” data relating to salary, and “other income” data relating to customer 152's other sources of money. The number of categories may be greater or fewer depending on ATP Calculator 326 version. ATP Calculator 326 may recalculate and display the customer's total monthly income and Net Disposable Income (NDI) dynamically as data is entered. In some aspects, the temporal window for calculations may be set larger or smaller than a month, depending on the needs of financial service provider 110, the nature of the loan, and indication by user 112.

ATP Calculator 326 receives debt data in “Debt” box 814. Debts may include, for example, mortgage payments, rent, utility bills, credit card bills, insurance costs, membership fees for clubs or organizations, homeowner association dues, loan payments, tax payments, and any other recurring or non-recurring payments owed by the customer. Some debt amounts may be added to the calculator automatically by server 111. For example, debts listed on the customer's credit reports received from data reporting agencies 170 may be added to the customer 152's debt. Box 814 may display only prompts for pieces of debt data that have yet to be collected, to simplify the graphic user interface for user 112. In some aspects, box 814 may also list all types of debt data that have been collected, for user 112 to review and edit.

During the entry of debts, ATP Calculator 326 may calculate an amount of “imputed taxes,” and add this amount to customer 152's debt. Imputed taxes are an estimated amount of tax owed by customer 152 for any non-income job or life benefits they have received. For example, a customer 152 who is given a company car from their employer to use for personal uses, or who is given a free group life insurance policy, may be subject to taxes for those benefits. ATP Calculator 326 may prompt user 112 to gather data such as itemized information regarding the type and value of those benefits from customer 152, and enter the data into ATP Calculator 326 by operation of an “Add” button in box 814. After all benefit data has been received, ATP Calculator 326 may calculate an amount of imputed taxes. Calculation of imputed taxes may be performed by lookup table, or by multiplying the total value of benefits by a predetermined percentage value. For example, ATP Calculator 326 may multiply itemized benefits of $1,000 per month by a predetermined tax rate of 5%, to yield $50 per month of imputed taxes.

In some aspects, ATP Calculator 326 may automatically determine the amount of imputed taxes for customer 152 based on income. In such aspects, financial service provider 110 may create and store one or more lookup tables accessible by lending system 130 and/or server 111, having estimated imputed tax amounts or percentage multipliers that correspond to different ranges of annual income. For example, a lookup table may indicate that an annual income of $50,000 corresponds to $500 of imputed taxes. As another example, a lookup table may indicate that an annual income of $50,000-$75,000 corresponds to a multiplier of 0.08. ATP Calculator 326 determines the amount of imputed taxes that correspond to the annual income, and completes calculation of the imputed taxes.

ATP Calculator 326 may calculate an amount of imputed “Shelter Expenses,” and add the amount added to the customer's debt by prompting user 112 to enter data in the “Shelter Exp” portion of box 814. Shelter expenses may include, for example, cost-of-living expenses estimated for the customer, such as rent, insurance, food, gas, and utility expenses. ATP Calculator 326 may prompt user 112 to gather itemized information regarding the type and value of those expenses from the customer, and enter them into ATP Calculator 326 by operation of another “Add” button in box 814. After all itemized values have been received, ATP Calculator 326 may calculate an amount of total shelter expenses. When itemized expenses are entered, ATP Calculator 326 may apply the total value to the total amount of debt. In some aspects, ATP Calculator 326 may automatically determine the amount of imputed shelter expenses for the customer based on annual income and/or geographical location. In such aspects, financial service provider 110 may create and store one or more lookup tables accessible by lending system 130 and/or server 111, having estimated imputed shelter expense amounts or percentage multipliers that correspond to different ranges of customer 152's income, similar to the examples above with respect to imputed taxes. ATP Calculator 326 may look up an amount of imputed shelter expenses that correspond to income. The amount may also be determined according to the geographical location of customer 152. For example, residence in New York City would correspond to higher estimated shelter expenses than residence in a rural area.

Lookup tables, percentage values, and/or other statistical values used for calculating imputed taxes and imputed shelter expenses may be preset by financial service provider 110, a user, or other computing system or software executed by a processor(s) and electronically stored for access by lending system 130 or server 111. Alternatively, server 111 may dynamically determine such statistical values for usage by ATP Calculator 326, by collecting trend and census data from data reporting agencies 170 such as, for example, a private or government census bureau, or an entity that provides current financial statistical data. As an example, server 111 may determine average cost-of-living values for different cities or geographical regions by gathering average rent, food, utility, and transportation prices from a data reporting agency 170 such as the Federal Census Bureau.

The loan amount customer 152 requested may also be added to debts automatically or manually in box 814. In some aspects, user 112 may enter the total loan amount requested, and allow ATP Calculator 326 to calculate the monthly payment amount. If customer 152 is requesting a line of credit or credit line increase, ATP Calculator 326 may determine the minimum monthly payment associated with the requested credit line limit based on interest rates available for customer 152.

ATP Calculator continuously calculates a “Total Monthly Obligation” upon any entry or modification of debt values by summing all monthly debt amounts, and displays the updated amount at the bottom of box 814. In addition, NDI is recalculated and updated in box 812 as debt values are added or modified.

In area 816, ATP Calculator 326 may display one or more updated analysis results. Results are recalculated and updated in real-time as any data is added, removed, or modified. Displayed results may include any information that may be useful to user 112 for approving or disapproving the loan. Different versions of ATP Calculator 326 may display different types of results.

In some embodiments ATP Calculator 326 may automatically compare financial data received from customer 152 to information from customer 152's credit report, such as income and debt data. Information considered in the comparison may include FICO score, DTI, complexity of debt, and historical repayment rates. If ATP Calculator 326 determines that a predetermined number of financial data items on customer 152's credit reports do not correlate to the income data received from customer 152, ATP Calculator 326 may indicate to user 112 that further investigation is required, and request income pre-screening (not shown in figures). ATP Calculator 326 may include a module for income pre-screening module that compares customer 152's credit report information and/or received financial data to one or more confidence thresholds predetermined by financial service provider 110. When ATP Calculator 326 determines that the confidence of customer 152's financial health is low or uncertain, ATP Calculator 326 may advise via a notification displayed on the calculator that further investigation into income is required. In some embodiments, ATP Calculator 326 may indicate the need for income pre-screening if customer 152 claims to have an income above an upper predetermined threshold, such as an annual income of over $1,000,000, or below a lower predetermined threshold.

User 112 may select Reset button 818 to clear the fields of ATP Calculator 326. In some aspects, Reset button 818 may reset values of ATP Calculator 326 to the previously collected customer data values.

ATP Calculator 326 may include buttons that may be manipulated to select different configurations of portions of ATP Calculator 326, such as buttons 820 shown in box 812. Different versions of ATP Calculator 326 may display different types and configurations of buttons 820, depending on the calculations used for that particular version of ATP Calculator 326, and the particular data used. Some or all of buttons 820 may include binary toggles to switch ATP Calculator 326 from one version to another. For example, buttons 820 may include a binary toggle that indicates customer 152 lives in a high rent state (“HRS”), and a corresponding (“NON”) toggle to indicate customer 152 does not live in a high rent state. Designations of high rent states and low rent states may be predetermined by financial service provider 110 and stored in memory for use by ATP Calculator 326. If customer 152 resides in a designated high rent state, the imputed shelter expense calculation may weight income more heavily, in order to fit the statistical norm for those high rent states. In the alternative, the NON high rent state toggle may cause ATP Calculator 326 to place a different, possibly lower weighting on income to impute shelter expenses.

In another example, buttons 820 may include a binary toggle that indicates customer 152 owns his or her home (“OWN”) and a corresponding (“NON”) toggle to indicate customer 152 does not own their home. Selection of the OWN toggle may be used to determine imputed taxes resulting from home ownership when a mortgage payment is not specified. The assumption is that mortgage payments include the taxes related to home ownership, whereas home ownership without a current mortgage payment will still hold tax obligation that must be considered in the calculation of ability to pay.

In a further example, buttons 820 may include a binary toggle that indicates customer 152 pays a fee, such as an annual account fee, to financial service provider 110 (“AMF”) and a corresponding (“NON”) toggle to indicate customer 152 does not pay any annual member fee. Selection of the AMF toggle may cause ATP Calculator 326 to apply a different RepayRate, as discussed above. In some embodiments, the AMF toggle may be used to indicate that customer 152 is requesting a loan that has an associated annual member fee, such as a credit card having an annual fee.

Buttons 820 may be active or hidden in various versions of ATP Calculator 326. Their inclusion or exclusion may be determined by the context for which each version of the calculator is applied. For example, the AMF toggle may not be presented on ATP Calculator 326 versions used in contexts where accounts having annual member fees do not exist.

FIG. 9A shows an ATP Calculator 326 graphic user interface consistent with disclosed embodiments. In one aspect, the interface of FIG. 9A may reflect an exemplary version of ATP Calculator 326 (denoted by the selection of toggle switch “B”) which may be used for assessing the ATP for a customer 152 who requests a loan for purchasing high risk items, such as power sport vehicles. Some versions of ATP Calculator 326 may include criteria mode selection box 910. ATP Calculator 326 receives selection of a mode from user 112 in box 910. Different modes, such as “YA” and “YB” for one or more of the ATP Calculator 326 versions provide additional customization of the ATP Calculator 326 for the customer's particular situation. For example, receipt of user 112's selection of “YA” in box 910 may indicate that customer 152 has sufficient credit report data, and cause ATP Calculator 326 to automatically populate appropriate income and debt fields, whereas user 112's selection of “YB” may indicate that customer 152's credit history is insufficient, causing ATP Calculator 326 to request additional, itemized financial data.

In Asset Based Limit Assignment box 920, user 112 may select the product category of the intended purchase. For example, if customer 152 wishes to purchase a jet ski, “Personal Water Craft” may be selected as the Product Category. Financial service provider 110 may assign different levels of risk to different product categories, and store electronically, such as in a memory having one or more look up tables or rule sets, for access by lending system 130 or server 111. For example, a snow mobile may be identified as a high-risk item, whereas a canoe may be risk item. Financial service provider 110 may determine risk levels based on criteria such as, for example, the nature of items belonging to a particular product category, the nature of one or more activities their usage, the probability of incurring damage or loss of the items from their usage, the price of the items, estimated depreciation rates of the items, and any other financial or social aspects of items in the product category. Upon selection of a product category, lending system 130 or server 111 may retrieve the associated risk level for entry into ATP Calculator 326.

ATP Calculator 326 may receive the Manufacturer Suggested Retail Price (MSRP) of the item, and the loan amount requested, from user 112, automatically from customer 152 during the automated survey, or via request from server 111 to a data reporting agency 170 (e.g. the item vendor). As data is received, ATP Calculator 326 may automatically recalculate results, and display updated results. The displayed results may include an indication of the maximum loan limit (“Maximum Limit”) that will be provided to the customer based on the risk level of the item.

FIG. 9B shows an exemplary flowchart of a Maximum Limit calculation and display process, consistent with certain disclosed embodiments. In one embodiment, one or more operations of the Maximum Limit calculation and display process may be performed by lending system 130 (via, e.g., ATP Calculator 326) or server 111. In step 914, NDI may be calculated by determining the difference between customer 152's monthly income and total monthly obligations. In one aspect, NDI may be compared to a threshold amount that may be preset by financial service provider 110 (step 920), such as $25. If NDI is less than the preset amount, ATP Calculator 326 may determine that customer 152 does not have sufficient disposable income to continue the loan application process. ATP Calculator 326 may set Maximum Limit to zero (step 922) and display the Maximum Limit of zero in step 924.

If ATP Calculator 326 determines that customer 152's NDI is not less than the preset amount in step 620, DTI is compared to a preset threshold percentage (step 934), such as 50%. If DTI is greater than the preset percentage, ATP Calculator 326 may determine that customer 152 has too much preexisting debt to be approved for the loan, causing ATP Calculator 326 to set Maximum Limit to zero in step 922, and display the result in step 624. If DTI is determined to be equal to or less than the preset percentage in step 934, ATP Calculator 326 may calculate an Asset Maximum Limit (step 936). The Asset Maximum Limit may be calculated based on the determined risk level associated with the selected Product Category, as well as the MSRP. For example, suppose customer 152 applies for a loan to purchase a jet ski having a MSRP of $8,000. ATP Calculator 326 may determine that the jet ski is a high risk item based on its product category, and determine via lookup table that such an item is only allowed a loan equal to 50% of the MSRP, to reduce the risk exposure of financial service provider 110. ATP Calculator 326 may set the Asset Maximum Limit at $4,000 (50% of $8,000).

In step 926, ATP Calculator 326 may calculate a Maximum Limit for customer 152 by dividing NDI by RepayRate. For example, if customer 152 has Net Disposable Income of $50 per month, and is given a 5% RepayRate, Maximum Limit is $1,000 ($50/0.05).

ATP Calculator 326 may determine whether the calculated Asset Maximum Limit is greater than or equal to the Maximum Limit in step 938. If the determination is positive, then the Max Limit is set to the Asset Maximum Limit and displayed in step 942. For example, even if ATP Calculator 326 determines customer 152 could a $7,000 loan, the Maximum Limit displayed would be $4,000 (50% of $8,000 jet ski MSRP) due to the high risk associated with the product category.

If ATP Calculator 326 determines that the Maximum Limit for customer 152 is less than the Asset Maximum Limit (step 938), then customer 152 does not have the ability to pay the maximum loan available for the item. The Max Limit is set to the Maximum Limit calculated for customer 152, and displayed in step 940. For example, if the $8,000 jet ski discussed above qualifies for a $4,000 loan, but customer 152 is determined to only have the ability to pay a $3,000 loan, ATP Calculator 326 may display a Max Limit of $3,000.

FIG. 10 shows an ATP Calculator 326 graphic user interface, consistent with disclosed embodiments. In one embodiment, the interface of FIG. 10 may reflect an exemplary version of ATP Calculator 326 (denoted by the selection of toggle switch “C”) which may request itemized entry of debts when, for example, customer 152 has insufficient credit report data. ATP Calculator 326 may generate and display itemized debt entry box 1010 for prompting entry of itemized bill amounts. User 112 may enter any bill amounts and other monthly obligations, for calculation of customer 152's Total Monthly Obligation.

In some aspects, ATP Calculator 326 may generate and display box 1010 connection with other ATP Calculator versions. For example, in version “B” illustrated in FIG. 9, selection of mode “YB” may indicate that customer 152 has insufficient credit report data, and cause ATP Calculator 326 to display box 1010 in place of the “Debt” box shown in FIG. 9. By providing multiple versions and modes of ATP Calculator 326 that are easily selectable, user 112 may quickly and efficiently select the calculator that best suits customer 152's situation.

Although aspects of the disclosed embodiments are described as being associated with data stored in memory and other tangible computer-readable storage mediums, one skilled in the art will appreciate that these aspects can also be stored on and executed from many types of non-transitory, tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. An apparatus for determining a customer's ability to pay (ATP) a debt, comprising:
one or more memory devices having stored thereon software instructions; and
one or more processors configured to execute the software instructions to:
receive a selection of a first ATP calculator version from among of a set of ATP calculator versions available for operation,
provide an interface associated with the first ATP calculator version,
receive income data associated with a customer through the interface,
receive debt data that includes an amount of a requested loan by the customer through the interface,
calculate an amount of total obligations for the customer based on the debt data,
calculate an amount of total income for the customer based on the received income data,
calculate a debt to income ratio for the customer based on the amount of total obligations and total income for the customer,
determine, based on the determined debt to income ratio, an ability to pay the requested loan, and
provide an indication of the determined ability to pay the requested loan in the interface associated with the first ATP calculator version.

2. The apparatus of claim 1, wherein the one or more processors are further configured to:
receive value information regarding one or more non-income job benefits for the customer;
calculate an imputed tax amount based on the value information for the customer; and
calculate the amount of total obligations for the customer based on the imputed tax amount.

3. The apparatus of claim 1, wherein the one or more processors are further configured to:
receive authorization to access one or more credit reports for the customer;
receive the one or more credit reports; and
analyze the received one or more credit reports,
wherein the debt to income ratio is calculated based in part on the analyzed one or more credit reports.

4. The apparatus of claim 1, wherein the one or more processors are further configured to:
calculate a net disposable income (NDI) amount based on the amount of total obligations and total income for the customer,
wherein the customer's ability to pay the loan is determined based in part on the calculated net disposable income.

5. The apparatus of claim 4, wherein the one or more processors are further configured to:
calculate a maximum loan limit based on the NDI amount and a repayment rate,
wherein the customer's ability to pay the loan is determined based in part on the calculated maximum loan limit.

6. The apparatus of claim 5, wherein the one or more processors indicate that the ATP fails when the amount of the requested loan is greater than the maximum loan limit, and
wherein the one or more processors indicate that the ATP passes when the maximum loan limit is greater than or equal to the amount of the requested loan.

7. The apparatus of claim 1, wherein the one or more processors are further configured to:
receive a selection of a second ATP calculator version through the interface reflecting the first ATP calculator version;
generate a second interface associated with the second ATP calculator version;
automatically populate one or more fields in the second interface associated with the second ATP calculator version; and
generate a request for at least one of additional income data or debt data for the customer,
wherein the request for additional income data or debt data includes a request for income data or debt data that is not provided in the interface associated with the first ATP calculator version.

8. A computer-implemented method for determining a customer's ability to pay a debt, comprising:
receiving, by one or more processors, a selection of a first ATP calculator version from among of a set of ATP calculator versions available for operation,
providing, by the one or more processors, an interface associated with the first ATP calculator version,
receiving, by the one or more processors, income data associated with a customer through the interface,
receiving, by the one or more processors, debt data that includes an amount of a requested loan by the customer through the interface,
calculating, by the one or more processors, an amount of total obligations for the customer based on the debt data,
calculating, by the one or more processors, an amount of total income for the customer based on the received income data,
calculating, by the one or more processors, a debt to income ratio for the customer based on the amount of total obligations and total income for the customer,
determining, by the one or more processors, based on the determined debt to income ratio, an ability to pay the requested loan, and
providing, by the one or more processors, an indication of the determined ability to pay the requested loan in the interface associated with the first ATP calculator version.

9. The method of claim 8, further comprising:
receiving value information regarding one or more non-income job benefits;
calculating, by the one or more processors, an imputed tax amount based on the value information for the customer; and
calculating the amount of total obligations for the customer based on the imputed tax amount.

10. The method of claim 8, further comprising:
receiving authorization to access one or more credit reports for the customer;
receiving the one or more credit reports; and
analyzing the received one or more credit reports,
wherein the debt to income ratio is calculated based in part on the analyzed one or more credit reports.

11. The method of claim 8, further comprising:
calculating a net disposable income (NDI) amount based on the amount of total obligations and total income for the customer,
wherein the customer's ability to pay the loan is determined based in part on the calculated net disposable income.

12. The method of claim 11, further comprising:
calculating a maximum loan limit based on the NDI amount and a repayment rate,
wherein the customer's ability to pay the loan is determined based in part on the calculated maximum loan limit.

13. The method of claim 12, wherein the one or more processors indicate that the ATP fails when the amount of the requested loan is greater than the maximum loan limit, and
wherein the one or more processors indicate that the ATP passes when the maximum loan limit is greater than or equal to the amount of the requested loan.

14. The method of claim 8, further comprising:
receiving, by the one or more processors, a selection of a second ATP calculator version through the interface reflecting the first ATP calculator version;
generating, by the one or more processors, a second interface associated with the second ATP calculator version;
automatically populating, by the one or more processors, one or more fields in the second interface associated with the second ATP calculator version; and
generating, by the one or more processors, a request for at least one of additional income data or debt data for the customer,
wherein the request for additional income data or debt data includes a request for income data or debt data that is not provided in the interface associated with the first ATP calculator version.

15. A non-transitory computer readable medium having stored thereon instructions for causing one or more processors to perform a method for determining a customer's ability to pay a debt, the method comprising:
receiving a selection of a first ATP calculator version from among of a set of ATP calculator versions available for operation,
providing an interface associated with the first ATP calculator version,
receiving income data associated with a customer through the interface,
receiving debt data that includes an amount of a requested loan by the customer through the interface,
calculating an amount of total obligations for the customer based on the debt data,
calculating an amount of total income for the customer based on the received income data,
calculating a debt to income ratio for the customer based on the amount of total obligations and total income for the customer,
determining based on the determined debt to income ratio, an ability to pay the requested loan, and
providing an indication of the determined ability to pay the requested loan in the interface associated with the first ATP calculator version.

16. The non-transitory computer readable medium of claim 15, wherein the method further comprises:
receiving value information regarding one or more non-income job benefits;
calculating, an imputed tax amount based on the value information for the customer; and
calculating the amount of total obligations for the customer based on the imputed tax amount.

17. The non-transitory computer readable medium of claim 15, wherein the method further comprises:
receiving authorization to access one or more credit reports for the customer;
receiving the one or more credit reports; and
analyzing the received one or more credit reports,
wherein the debt to income ratio is calculated based in part on the analyzed one or more credit reports.

18. The non-transitory computer readable medium of claim 15, wherein the method further comprises:
calculating a net disposable income (NDI) amount based on the amount of total obligations and total income for the customer,
wherein the customer's ability to pay the loan is determined based in part on the calculated net disposable income.

19. The non-transitory computer readable medium of claim 18, wherein the method further comprises:
calculating a maximum loan limit based on the NDI amount and a repayment rate,
wherein the customer's ability to pay the loan is determined based in part on the calculated maximum loan limit.

20. The non-transitory computer readable medium of claim 19, wherein the indication of the determined ATP is failure when the amount of the requested loan is greater than the maximum loan limit, and
wherein indication of the determined ATP is passing when the maximum loan limit is greater than or equal to the amount of the requested loan.

21. The non-transitory computer readable medium of claim 15, wherein the method further comprises:
receiving a selection of a second ATP calculator version through the interface reflecting the first ATP calculator version;
generating a second interface associated with the second ATP calculator version;
automatically populating one or more fields in the second interface associated with the second ATP calculator version; and
generating a request for at least one of additional income data or debt data for the customer,
wherein the request for additional income data or debt data includes a request for income data or debt data that is not provided in the interface associated with the first ATP calculator version.
